(19) United States
(12) Patent Application Publication
(10) Pub. No.: US 2025/0327944 A1
(43) Pub. Date: Oct. 23, 2025

(54) FAST-CONSTRAINED 3D INVERSION METHOD FOR GRAVITY AND FULL TENSOR GRAVITY GRADIOMETRY (FTG) DATA

(71) Applicant: Technology Innovation Institute - Sole Proprietorship LLC, Masdar City (AE)

(72) Inventors: Meixia Geng, Abu Dhabi (AE); Qingjie Yang, Abu Dhabi (AE); Chaouki Kasmi, Abu Dhabi (AE)

(73) Assignee: Technology Innovation Institute - Sole Proprietorship LLC, Masdar City (AE)

(21) Appl. No.: 19/051,416

(22) Filed: Feb. 12, 2025

Related U.S. Application Data
(60) Provisional application No. 63/635,031, filed on Apr. 17, 2024.

(51) Int. Cl. G01V 7/04; G06F 17/16

(52) U.S. Cl. CPC G01V 7/04; G06F 17/16

(57) ABSTRACT

A method for 3D inversion of Full Tensor Gradiometry (FTG) data comprising receiving observed FTG data, performing a kernel matrix calculation on a subset of the observed FTG data and the gravity anomaly data, performing one-time forward modeling in a wavenumber domain to produce predicted FTG data and predicted gravity anomaly data for the reference density model, performing a residual between the observed data and predicted data, performing a depth-weighting function, a model covariance matrix, and data error covariance matrix on the observed FTG data and observed gravity anomaly data, obtaining a model update based on the depth-weighting function, kernel matrix, the model covariance matrix and the data error covariance matrix, and the residual between the observed FTG data and the predicted FTG data in the wavenumber domain, and performing inversion by directly obtaining an inverted model based on the model update and reference model.

### CROSS-REFERENCE TO RELATED APPLICATIONS

This application claims priority to U.S. Provisional Application No. 63/635,031, filed Apr. 17, 2024, which is incorporated by reference in its entirety.

### FIELD

A system and method for fast-constrained 3D inversion method for gravity and full tensor gravity gradiometry (FTG) data.

### BACKGROUND

Gravity and Full Tensor Gradiometry (FTG) data are commonly used in the field of geophysics to estimate models of Earth's subsurface. These models can provide insights into the geological structures and properties of the Earth's subsurface, which can be useful in various applications such as mineral exploration, oil and gas exploration, and geotechnical investigations.

Three-dimensional (3D) inversion is a computational process that estimates a model of the subsurface from gravity and FTG data. This process involves iteratively updating an initial model based on the residual between predicted and observed data until the residual reaches a noise level.

Conventional 3D inversion of gravity and FTG data is typically performed by inputting the observation data, setting the initial model and calculating the kernel matrix, calculating the prediction data and the cost function, calculating the gradient vector or the update model, updating the initial model along the direction of the updated model. This process is repeated iteratively until a predetermined convergence criterion is met.

The conventional 3D inversion of gravity and FTG data faces numerous challenges and issues including but not limited to time consumption and non-uniqueness of solutions. In the traditional inversion method, a smoothness constraint or a compact constraint are usually adopted to stabilize the inversions, and a conjugate gradient (CG) method is used to solve the inversion equation. However, both the smoothness and the compactness constraints only provide broad and loose constraints of the model. They cannot fully utilize the available prior information, such as the density information, orientation, spatial extent, and interface from the seismic data. Moreover, the calculation and storage of the kernel matrix of the gravity and FTG data is time-consuming, which limits the application of 3D gravity and FTG data inversion on a large scale.

### SUMMARY

In one aspect, the present disclosure relates to a method for 3D inversion of Full Tensor Gradiometry (FTG) data, the method comprising receiving, by a processor, observed FTG data collected by an FTG sensor, inputting, by the processor, the observed FTG data, gravity anomaly data and a reference density model, performing, by the processor, a kernel matrix calculation on a subset of the observed FTG data and the gravity anomaly data, performing, by the processor, one-time forward modeling in a wavenumber domain to produce predicted FTG data and predicted gravity anomaly data for the reference density model, performing a residual between the observed data and predicted data, performing, by the processor, a depth-weighting function, a model covariance matrix, and data error covariance matrix on the observed FTG data and observed gravity anomaly data, obtaining, by the processor, a model update based on the depth-weighting function, kernel matrix, the model covariance matrix and the data error covariance matrix, and the residual between the observed FTG data and the predicted FTG data in the wavenumber domain, and performing inversion by directly obtaining, by the processor, an inverted model based on the model update and reference model.

In embodiments of this aspect, the disclosed method according to any one of the above example embodiments, further comprising utilizing, by the processor, a biconjugate gradient stabilized method (BiCGSTAB) to perform the inversion, the one-time forward modeling, the depth-weighting function, the model covariance matrix, and the data error covariance matrix.

In embodiments of this aspect, the disclosed method according to any one of the above example embodiments, further comprising utilizing, by the processor, Graphics Processing Unit (GPU) acceleration to enhance computational efficiency of the inversion.

In embodiments of this aspect, the disclosed method according to any one of the above example embodiments, further comprising integrating, by the processor, prior information into the inversion through the model covariance matrix obtained by calculating spatial variogram functions to provide constraints on the inversion.

In embodiments of this aspect, the disclosed method according to any one of the above example embodiments, further comprising incorporating, by the processor, topography into the inversion to define an upper boundary of the model.

In embodiments of this aspect, the disclosed method according to any one of the above example embodiments, further comprising processing, by the processor, Total Magnetic Intensity (TMI) anomaly data to obtain Reduction to the Pole (RTP) or Reduction to the Equator (RTE) anomaly data for improved efficiency of inversion.

In embodiments of this aspect, the disclosed method according to any one of the above example embodiments, further comprising deriving, by the processor, the model update directly from the one-time forward modeling and inversion without iterative refinement.

In embodiments of this aspect, the disclosed method according to any one of the above example embodiments, further comprising deriving, by the processor, the model update using computational techniques that minimize a memory footprint by avoiding storage of large matrices.

In embodiments of this aspect, the disclosed method according to any one of the above example embodiments, further comprising deriving, by the processor, the model update using a computational strategy that calculates the kernel matrix and the model covariance matrix in a manner that reduces storage requirements.

In embodiments of this aspect, the disclosed method according to any one of the above example embodiments, further comprising deriving, by the processor, the model update by calculating and utilizing a first row of the kernel matrix and the model covariance matrix to represent the behavior of full matrices.

In one aspect, the present disclosure relates to a system for 3D inversion of Full Tensor Gradiometry (FTG) data, the system comprising a processor configured to receive observed FTG data collected by an FTG sensor, input the observed FTG data, observed gravity anomaly data and a reference density model, perform a kernel matrix calculation on a subset of the observed FTG data and the observed gravity anomaly data, execute one-time forward modeling in a wavenumber domain to produce predicted FTG data and predicted gravity anomaly data for the reference density model, apply a depth-weighting function, compute a model covariance matrix, and compute a data error covariance matrix on the observed FTG data and observed gravity anomaly data, and compute a residual between the observed FTG data, the observed gravity anomaly data, the predicted FTG data and the predicted gravity anomaly data, obtain a model update based on the depth-weighting function, the kernel matrix, the model covariance matrix, the data error covariance matrix, and the residual between the observed and predicted FTG data and the predicted gravity anomaly data in the wavenumber domain, and perform an inversion to directly obtain an inverted model based on the model update and reference model.

In embodiments of this aspect, the disclosed system according to any one of the above example embodiments, wherein the processor is further configured to utilize a biconjugate gradient stabilized method (BiCGSTAB) for performing the inversion, the one-time forward modeling, the depth-weighting function, the model covariance matrix, and the data error covariance matrix.

In embodiments of this aspect, the disclosed system according to any one of the above example embodiments, wherein the processor is further configured to employ Graphics Processing Unit (GPU) acceleration to enhance computational efficiency of the inversion.

In embodiments of this aspect, the disclosed system according to any one of the above example embodiments, wherein the processor is further configured to integrate prior information into the inversion through the model covariance matrix by calculating spatial variogram functions to provide constraints on the inversion.

In embodiments of this aspect, the disclosed system according to any one of the above example embodiments, wherein the processor is further configured to incorporate topography into the inversion to define an upper boundary of the model.

In embodiments of this aspect, the disclosed system according to any one of the above example embodiments, wherein the processor is further configured to process Total Magnetic Intensity (TMI) anomaly data to obtain Reduction to the Pole (RTP) or Reduction to the Equator (RTE) anomaly data for improved efficiency of inversion.

In embodiments of this aspect, the disclosed system according to any one of the above example embodiments, wherein the processor is configured to derive the model update directly from the one-time forward modeling and inversion calculations without iterative refinement.

In embodiments of this aspect, the disclosed system according to any one of the above example embodiments, wherein the processor is configured to derive the model update using computational techniques that minimize a memory footprint by avoiding storage of large matrices.

In embodiments of this aspect, the disclosed system according to any one of the above example embodiments, wherein the processor is configured to derive the model update using a computational strategy that calculates the kernel matrix and the model covariance matrix in a manner that reduces storage requirements.

In embodiments of this aspect, the disclosed system according to any one of the above example embodiments, wherein the processor is configured to derive the model update by calculating and utilizing a first row of the kernel matrix and the model covariance matrix to represent a behavior of full matrices.

### BRIEF DESCRIPTION OF THE DRAWINGS

So that the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1 is an illustrative depiction of an aerial collection of FTG data, showing an airplane equipped with an FTG sensor platform flying over a terrain, according to an example embodiment.

FIG. 2 presents a perspective view of an FTG sensor platform, showing a rotating table supporting four accelerometers and a controller managing the operation and data collection process, according to an example embodiment.

FIG. 3 provides a schematic representation of FTG measurement axes and gradients, illustrating the comprehensive nature of the FTG data collection process over the terrain surface, according to an example embodiment.

FIG. 4 presents a high-level flowchart of FTG data collection and inversion, outlining the sequential steps involved in the process from data collection to the final inversion output, according to an example embodiment.

FIG. 5 presents a detailed flowchart of FTG data collection and inversion, outlining the sequential steps involved in the process from data input to the final inverted model output, according to an example embodiment.

FIG. 6 presents a diagram of a networked system for FTG data processing, showing a user device connected via a network to an FTG data processing server and an FTG database server, according to an example embodiment.

FIG. 7 presents a diagram of representative hardware of the user device and FTG servers, illustrating the flow of information and control signals within the system, according to an example embodiment.

FIG. 8 presents a set of six gravity gradient tensor component maps showing spatial variations in the gravitational field for the Budgell Harbour Stock in Newfoundland, according to an example embodiment.

FIG. 9 presents a density model derived from the joint inversion of the FTG data shown in FIG. 8, highlighting a magmatic intrusion body beneath the surface, according to an example embodiment.

### DETAILED DESCRIPTION

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatus as known by one of ordinary skill in the relevant art may not be discussed in detail but are intended to be part of the specification where appropriate. In all the examples illustrated and discussed herein, any specific values should be interpreted to be illustrative and non-limiting. Thus, other example embodiments may have different values. Notice that similar reference numerals and letters refer to similar items in the following figures, and thus once an item is defined in one figure, it is possible that it need not be further discussed for the following figures. Below, the example embodiments will be described with reference to the accompanying figures.

The present disclosure is in the field of geophysics, specifically focusing on methods and systems for performing three-dimensional (3D) inversion of gravity and Full Tensor Gradiometry (FTG) data. Gravity data generally refers to scalar measurements of the Earth's gravitational field at specific locations, while FTG data is a more advanced type of gravity data that generally involves the measurement of the spatial derivatives of the Earth's gravitational field in all three dimensions. Gravity and FTG data are commonly used in geophysics to estimate models of the Earth's subsurface. These models can provide insights into the geological structures and properties of the Earth's subsurface, which can be useful in various applications such as mineral exploration, oil and gas exploration, and geotechnical investigations.

Three-dimensional (3D) inversion is a computational process that estimates a model of the subsurface from gravity and FTG data. This process involves iteratively updating an initial model based on the residual between predicted and observed data until the residual reach a noise level. The inversion process can be computationally intensive and time-consuming, especially when dealing with large datasets. Therefore, efficient methods and systems for performing 3D inversion of gravity and FTG data are of great interest in the field of geophysics.

The disclosed method and system provide an innovative solution for the 3D inversion of gravity and FTG data. The disclosed solution employs a biconjugate gradient stabilized method (BiCGSTAB) to solve the inversion equation, and all product calculations are performed in the wavenumber domain. The BiCGSTAB method is an iterative method used for the solution of nonsymmetric linear systems, and in the context of this disclosure, it is used to solve the inversion equation in the 3D inversion process. The approach greatly enhances the efficiency of the inversion procedure. The computation process involves vector operations and does not require the storage of large matrices, enabling the inversion of massive data on a laptop. The solution also integrates prior information into the inversion through spatial variogram functions, providing constraints on the inversion process. Furthermore, the topography is included in the inversion to constrain the top of the model. The disclosed solution offers several advantages over conventional FTG inversion methods. For example, the solution allows for the integration of various prior information into the inversion, has an analytical solution eliminating the need for iterative solutions, stores small vectors instead of large matrices, and performs all product calculations in the wavenumber domain, making the method faster and more efficient. Additionally, by transforming the Total Magnetic Intensity (TMI) anomaly to the Reduction to the Pole (RTP) or Reduction to the Equator (RTE) anomaly, the method can be used to rapidly invert magnetic data.

In some cases, the solution may be configured to integrate prior information into the inversion through spatial variogram functions to provide constraints on the inversion process. This allows the solution to incorporate additional information about the subsurface, such as the density information, orientation, spatial extent, and interface from other geophysical data, into the inversion process. This can improve the accuracy and reliability of the estimated subsurface model. In other cases, the solution may incorporate topography into the inversion to define the upper boundary of the model. The upper boundary of the model in geophysical inversion may define the topmost surface of the subsurface geological model, typically corresponding to the Earth's topography in the area of interest. It may serve as a constraint in the inversion process, ensuring that the gravitational effects of surface features are accurately accounted for in the estimation of the subsurface structures. This allows the solution to take into account the surface topography of the terrain when estimating the subsurface model. This can provide a more accurate representation of the subsurface, especially in areas with complex topography.

It is noted that while the solution outlined in the present document is described with respect to FTG data, the solution is not limited to FTG data alone but is inherently adaptable to handle any combination of the gravity gradient components. This flexibility allows for partial tensor gradiometer data. By accommodating different combinations of gradient component data, the inversion process can be tailored to specific datasets and geological scenarios, enhancing the versatility of the method. This adaptability ensures that the solution can be applied to a wide range of geophysical exploration tasks, providing a robust tool for subsurface modeling that can leverage the full spectrum of available gradient information.

The details and benefits of the disclosed solution are now described with respect to the accompanying figures.

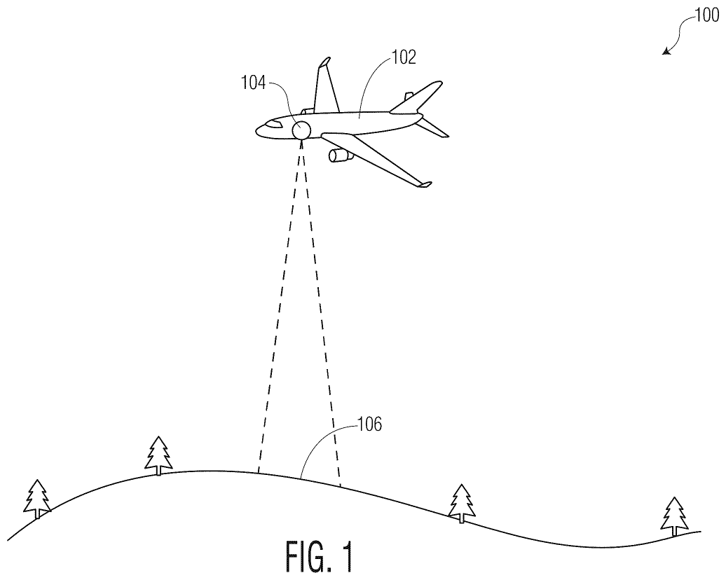

Referring to FIG. 1, an aerial collection of FTG data 100 is illustrated. In this process, an airplane 102 equipped with an FTG sensor platform 104 is used to collect data over a terrain 106. The airplane 102 flies over the terrain 106 along a specific path, as indicated by the dashed lines. The FTG sensor platform 104 on the airplane 102 measures the spatial derivatives of the Earth's gravitational field in all three dimensions, thereby collecting FTG data.

The FTG sensor platform 104 is designed to accurately measure the minute variations in the Earth's gravitational field caused by changes in the density of the subsurface. These measurements are collected as the airplane 102 flies over the terrain 106, providing a comprehensive coverage of the area of interest. The collected FTG data can then be used to estimate a model of the subsurface, providing insights into the geological structures and properties of the Earth's subsurface.

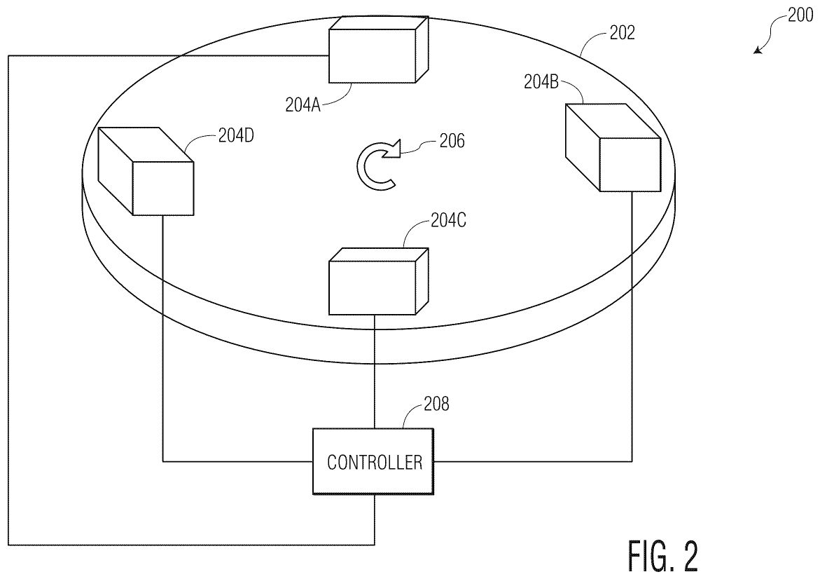

As described above, airplane 102 is equipped with FTG sensor platform 104. Referring to FIG. 2, a detailed perspective view of an example FTG sensor platform 200 is presented. The FTG sensor platform 200 is a compact and integrated assembly that is designed to accurately measure the spatial derivatives of the Earth's gravitational field. The FTG sensor platform 200 may include a centrally positioned rotating table 202 and four accelerometers, labeled 204A, 204B, 204C, and 204D, placed equidistantly around its perimeter. The rotation direction 206 of the rotating table 202 is indicated by a curved arrow. It is noted that FTG sensor platform 200 is just one example of a sensor configuration and may have any number of accelerometers and placement configurations around the platform.

The rotating table 202 serves as a support structure for the accelerometers 204A, 204B, 204C, and 204D. The accelerometers are sensitive devices that measure the rate of change of velocity due to gravity. They are strategically placed around the rotating table 202 to capture the spatial derivatives of the Earth's gravitational field in all three dimensions. The rotation of the table 202 allows the accelerometers to sample the gravitational field at different orientations, thereby providing a comprehensive coverage of the gravitational field.

In some embodiments, a controller 208 is connected to the rotating table 202 and the accelerometers 204A, 204B, 204C, and 204D. The controller 208 can manage the operation and data collection process of the FTG sensor platform 200, such as by controlling the rotation of the table 202 and the operation of the accelerometers, thereby ensuring that the data collection process is carried out accurately and efficiently. Of course, other FTG sensor platform configurations are possible.

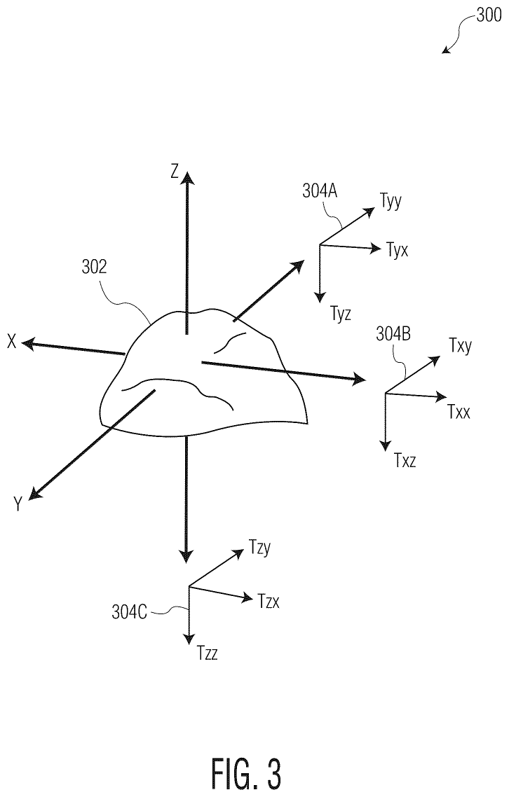

Referring to FIG. 3, a schematic representation of FTG measurement axes and gradients 300 is presented. The terrain surface 302 is depicted with various 3-axis gradients labeled 304A, 304B, and 304C. These gradients are shown emanating from the terrain surface 302, with arrows indicating the direction and orientation of the measured gravitational field components in three-dimensional space. The axes labeled X, Y, and Z provide a reference for the orientation of the gradients, illustrating the comprehensive nature of the FTG data collection process over the terrain surface 302.

In the context of FTG, the gradient terms Txx, Tyy, Tzz, Tyx, Tyz, Txy, Txz, Tzy, and Tzx represent the spatial derivatives of the Earth's gravitational field in three-dimensional space. These terms relate to the comprehensive nature of the FTG data collection process, as they provide a detailed and multi-faceted view of the subsurface geological structures. The gradient terms Txx, Tyy, and Tzz represent the second derivatives of the gravitational potential along the X, Y and Z axes respectively. These terms are often referred to as the diagonal elements of the gradient tensor and they provide information about the rate of change of the gravitational field in the respective directions. The off-diagonal elements of the gradient tensor, namely Tyx, Tyz, Txy, Txz, Tzy, and Tzx, represent the rate of change of the gravitational field in one direction with respect to another direction. For instance, Tyx represents the rate of change of the gravitational field in the y direction with respect to the x direction. These off-diagonal elements provide information about the variations in the gravitational field due to changes in the subsurface geological structures.

The gradient terms are of relevance in the FTG data collection process as they provide a comprehensive and detailed view of the subsurface geological structures. By measuring the spatial derivatives of the Earth's gravitational field in all three dimensions, the FTG method can provide a more accurate and detailed model of the subsurface compared to traditional gravity surveys. Furthermore, the gradient terms allow for the detection of smaller and deeper geological features that may not be detectable using traditional gravity surveys. This is because the gradient measurements are more sensitive to changes in the subsurface structures, making them particularly useful in mineral exploration, oil and gas exploration, and other geophysical applications.

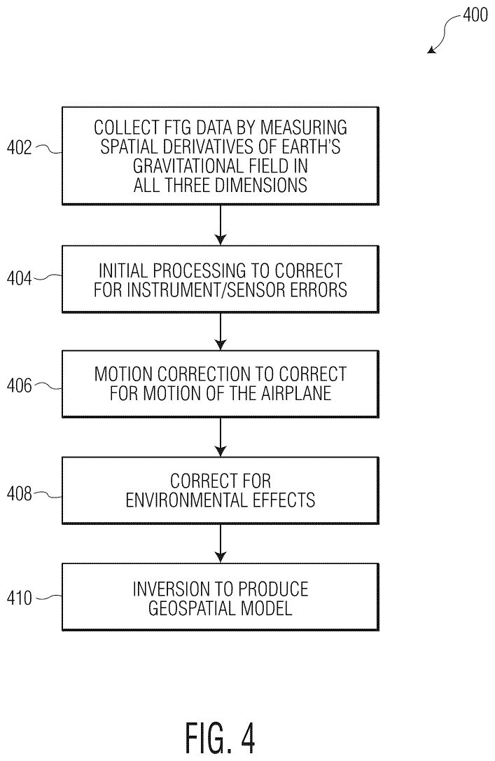

Referring to FIG. 4, a high-level flowchart of an FTG data collection and inversion process 400 is presented, outlining the sequential steps involved in the process from data collection to the final inversion output. The flowchart steps generally include but are not limited to data collection step 402, initial processing step 404, motion correction step 406, environmental correction step 408 and inversion step 410. These steps are now described in detail. The data collection step 402 involves collecting FTG data by measuring spatial derivatives of Earth's gravitational field in all three dimensions. This data collection process is performed by an FTG sensor platform, such as the FTG sensor platform 104 shown in FIG. 1, which is equipped on an airplane and flown over a terrain to collect data. It is noted that the FTG sensor platform is not necessarily part of the solution and prestored FTG data may simply be retrieved from an existing FTG database. In other words, data collection step 402 may be performed by another entity or in a different process and the resultant FTG data may be stored in a database for use by the disclosed solution.

Following the collection of the FTG data in data collection step 402, the next step in the process can be the initial processing step 404 as applied to the collected data. Initial processing step 404 is designed to correct for any errors or inaccuracies that may have been introduced during the data collection process due to instrument or sensor errors. The accuracy and reliability of the collected FTG data affect the inversion process, as errors or inaccuracies can lead to incorrect or misleading results.

These errors or inaccuracies can arise from a variety of sources, including but not limited to, instrument calibration errors, sensor noise, and environmental factors. Instrument calibration errors can occur if the FTG sensor platform is not properly calibrated before the data collection process. Sensor noise can be introduced by the noise characteristics of the sensors used in the FTG sensor platform.

In addition to the initial processing of the collected FTG data, motion correction step 406 may be undertaken to correct for the motion of the airplane during the data collection process. This step, referred to as the motion correction step 406, is relevant in ensuring the accuracy of the collected data. The rationale behind this step is that the motion of the airplane, which is an aspect of the data collection process, can introduce additional errors or inaccuracies into the collected FTG data. These errors or inaccuracies can distort the spatial derivatives of the Earth's gravitational field, leading to a less accurate representation of the subsurface geological structures.

Therefore, by implementing the motion correction step 406, these potential errors or inaccuracies are effectively corrected. This is achieved by adjusting the collected FTG data to account for the motion of the airplane, thereby ensuring that the data accurately represents the spatial derivatives of the Earth's gravitational field. This correction is applied irrespective of the motion of the airplane, meaning that it effectively neutralizes any distortions caused by the airplane's motion.

An additional step in the process, environmental correction step 408, involves the correction for environmental effects. Environmental effects, such as atmospheric conditions, temperature variations, and other environmental factors, can introduce errors or inaccuracies into the collected FTG data. These errors or inaccuracies can distort the spatial derivatives of the Earth's gravitational field, leading to a less accurate representation of the subsurface geological structures.

For instance, atmospheric conditions, such as air pressure, humidity, and wind speed, can affect the operation of the FTG sensor platform and the accuracy of the collected data. Similarly, temperature variations can cause thermal expansion or contraction of the sensor components, leading to measurement errors. Other environmental factors, such as electromagnetic interference, can also introduce noise into the collected data. By correcting for these environmental effects, environmental correction step 408 ensures that the collected FTG data accurately represents the spatial derivatives of the Earth's gravitational field, irrespective of the environmental conditions during the data collection process. It is noted that although correction steps 404, 406 and 408 are shown as being performed in a specific sequential order, these steps may be performed in a different sequential order or possibly even in parallel with one another.

Inversion step 410 involves the inversion of the FTG data to produce a geospatial model. This step involves performing a 3D inversion of the collected and processed FTG data to estimate a model of the subsurface. The traditional inversion process involves iteratively updating an initial model based on the residual between predicted and observed data until the residual reaches a noise level. It is noted that the system is configured to derive the model update directly from the one-time forward modeling without iterative refinement. This can enhance the efficiency of the inversion process by reducing the computational resources and time requirements. Moreover, the solution is configured to derive the model update using computational techniques that reduce the memory footprint by avoiding the storage of large matrices. This can further enhance the efficiency of the inversion process by reducing the memory requirements.

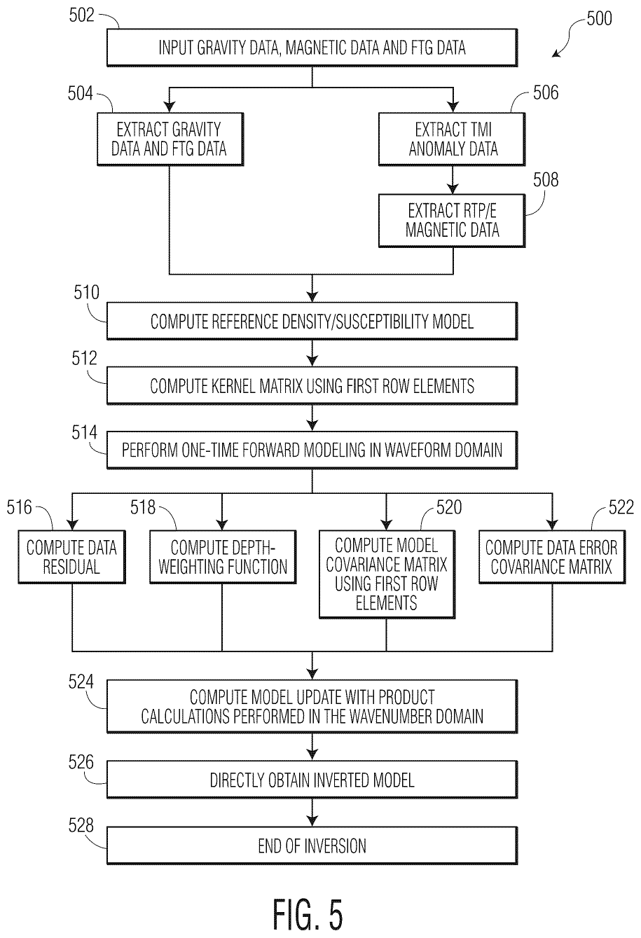

More specifically, the novel inversion method (performed in step 410) for 3D gravity and FTG data, employs the BiCGSTAB to solve the inversion equation, and all product calculations are performed in the wavenumber domain, enhancing the efficiency of the inversion procedure. The computation process may involve vector operations (e.g., only vector operations) and does not require the storage of large matrices, enabling the inversion of massive data with limited computational resources, such as on a laptop. The method also integrates prior information into the inversion through spatial variogram functions, providing constraints on the inversion process. Furthermore, the topography is included in the inversion to constrain the top of the model. The solution allows for the integration of various prior information into the inversion, has an analytical solution eliminating the iterative solutions, and performs all product calculations in the wavenumber domain, making the method faster and more efficient. Additionally, by transforming the TMI anomaly to the RTP or RTE anomaly, the method can be used to rapidly invert magnetic data. Details of the novel inversion method are now described with respect to FIG. 5.

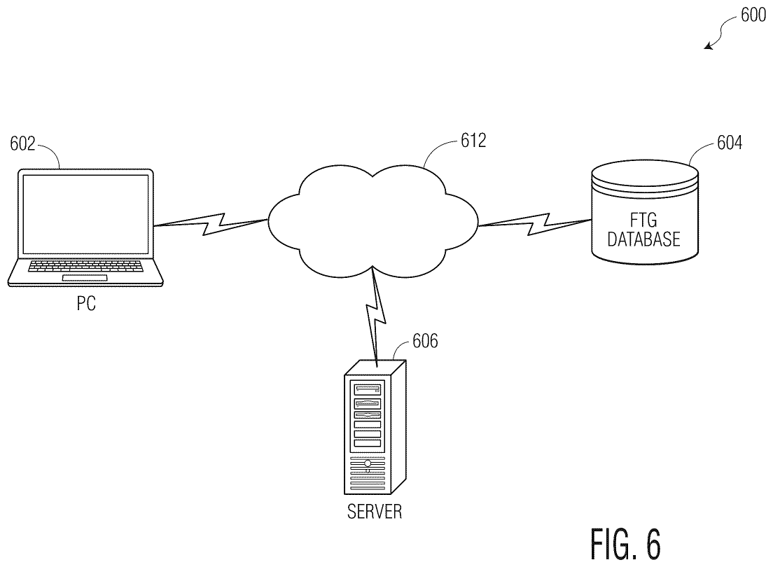

Referring to FIG. 5, a detailed flowchart of FTG data collection and inversion 500 is presented, outlining the sequential steps involved in the process from data input to the final inverted model output. The flowchart steps generally include but are not limited to data input step 502, data extraction steps 504, 506 and 508, reference model computation step 510, kernel matrix computation step 512, forward modeling step 514, residual computing step 516 computing the residual between the observed data and predicted data, depth weighting function computation step 518, model covariance matrix computation step 520, data error covariance matrix computation step 522, model update computation step 524, step 526 to obtain the inverted model, and inversion end step 528. These steps are now described in detail. Data input 502 involves inputting gravity, magnetic, and FTG data. This data input process can be performed by a processor in the FTG data processing server 606 that retrieves the data from database 604, as shown in FIG. 6.

Following the data input, the next steps involve extracting observed data such as gravity and FTG data 504, TMI anomaly data 506, and RTP/E magnetic anomaly data 508. These extraction steps may be performed by the processor in the FTG data processing server 606, which is configured to separate the different types of data for further processing. The extraction of the gravity and FTG data 504 and the TMI anomaly data 506 allows for the isolation of the specific data components that are relevant for the inversion process. It is noted that the disclosed solution is adaptable to handle one or more of gravity data, total magnetic data, and FTG data as shown in FIG. 5. More specifically, the disclosed solution may work solely with gravity data, solely with FTG data, or with a combination of gravity data and FTG data as shown in step 504. The inversion is performed on the available data. For example, when the input dataset includes a combination of both the single gravity anomaly dataset and FTG dataset the system performs a joint inversion of both datasets.

The next step in the process, denoted as reference model computation step 510, involves the computation of the reference density/susceptibility model m₀. The reference density/susceptibility model is a mathematical representation of the subsurface that is based on prior information about the geological structures and properties of the Earth's subsurface. This model serves as a starting point for the inversion process and is used to predict the FTG data and the gravity anomaly data of the inversion process. The computation of the reference density model is performed by the processor in the FTG data processing server, which is configured to generate this model based on the input data and the known physical laws governing the behavior of gravity and FTG data. The accuracy and reliability of this initial model can influence the outcome of the inversion process.

Once the reference model has been computed, the next step in the process is the calculation of the kernel matrix G, where calculating and storing the elements in the first row (e.g., only the first row) of the G as denoted as kernel matrix computation step 512. The kernel matrix is a mathematical construct that plays a role in the inversion process. It represents the relationship between the model parameters and the observed data, serving as a bridge that links the subsurface model to the observed FTG data. In kernel matrix computation step 512, instead of calculating the full kernel matrix, the process calculates a subset of the matrix elements including the elements in the first row (e.g., only the first row) of the kernel matrix G. These first row elements are the contributions of the prisms making up the model to a certain observed point. By using these first row elements, the full kernel matrix can be accurately recovered thereby enhancing the accuracy of the inversion process. The calculation of the kernel matrix sets the foundation for the subsequent steps of forward modeling, depth-weighting, and covariance matrix computation.

The process then proceeds with forward modeling step 514 which is known as one-time forward modeling dₚᵣₑ=Gm₀ where dₚᵣₑ is the predicted data, and m₀ is the reference model. Forward modeling is a technique used in geophysics to predict the response of a geological model to a particular set of physical processes. In the context of this disclosure, forward modeling is used to predict the FTG data and the gravity anomaly data for the reference density model. More specifically, the forward modeling is performed in the wavenumber domain, as opposed to the spatial domain. The wavenumber domain is a mathematical space where calculations are performed based on the number of wavelengths per unit distance. By performing the forward modeling in the wavenumber domain, the method can take advantage of the mathematical properties of this domain to enhance the efficiency and accuracy of the calculations. Furthermore, this forward modeling is performed just once, hence the term “one-time forward modeling”. This is a departure from traditional inversion methods, which often involve iterative forward modeling. By performing the forward modeling just once, the method can greatly reduce the computational resources and time requirements of the inversion process, making it more efficient and practical for large-scale applications.

Following the one-time forward modeling, the next steps are to calculate the residual between the observed FTG data and predicted FTG data, the depth weighting function, the model covariance matrix, and the data error covariance matrix. These steps are described below.

For example, in residual computing step 516, the process computes the data residual as the difference d_{obs}−dₚᵣₑ between the observed data d_{obs} and the predicted data dₚᵣₑ. This step quantifies the discrepancy between the actual measurements and the model's predictions. This is achieved by subtracting the predicted FTG data, which is derived from forward modeling of the reference model, from the observed FTG data collected by the sensor platform. The resulting residual data is a set of values that reflect the differences for each data point, providing insight into the accuracy of the current model.

In depth weighting function computation step 518, the process computes a depth-weighting function W. The depth-weighting function is a mathematical function that is used to adjust the weights of the data points in the inversion process based on their depth. This function allows the inversion process to take into account the varying sensitivity of the gravity and FTG measurements to the depth of the subsurface structures. The depth-weighting function directly influences the accuracy and reliability of the estimated subsurface model. By accurately computing the depth-weighting function, the processor in the FTG data processing server 606 can ensure that the inversion process accurately reflects the depth-dependent nature of the gravity and FTG measurements, thereby enhancing the overall accuracy and reliability of the 3D inversion process.

Following the one-time forward modeling, the next steps in the process involve the computation of two distinct matrices. The first is the model covariance matrix C_{M} on the first row elements, denoted as depth weighting function computation step 520 in the flowchart. The model covariance matrix is a mathematical construct that provides a measure of the amount of covariance, or variability, between pairs of elements in the model. This matrix is computed using the variogram function which based the priori information on the main geological structure of the research area. The elements in the first row of the matrix represent the correlation between a certain prism and all the other prisms making up the model. By using these first row elements, the model covariance matrix calculation can accurately reflect the initial conditions of the subsurface, thereby enhancing the accuracy of the inversion process. The second matrix computed is the data error covariance matrix C_{D}, denoted as data error covariance matrix computation step 522 in the flowchart. The data error covariance matrix is a measure of the expected variability in the observed data due to errors or inaccuracies. This matrix is computed based on the FTG collection and processing, and it provides a measure of the reliability of the observed data. By accurately computing the data error covariance matrix, the processor in the FTG data processing server can account for any errors or inaccuracies in the observed data, thereby enhancing the reliability of the inversion process.

At this stage of the process, the functions and matrices that have been computed in the previous steps are assembled together to form a model update equation in model update computation step 524. Equation (1) shown below is used to compute the model update δm in the wavenumber domain.

$$δ m = {W}^{- 1} {C}_{M} {W}^{- 1} {{G}^{T} ( G {W}^{- 1} {C}_{M} {W}^{- 1} {G}^{T} + {C}_{D} )}^{- 1} ( {d}_{obs} - {d}_{pre} ) \qquad ( Eq . 1 )$$

where BiCGSTAB is performed for the inversion (GW⁻¹C_{M}W⁻¹G^{T}+C_{D})⁻¹.

The model update equation is based on a mathematical operation that involves several components. As shown above, these components include the kernel matrix, the residual between d_{obs} and dₚᵣₑ the depth-weighting function, the model covariance matrix, and the data error covariance matrix. Each of these components plays a specific role in the inversion process and contributes to the accuracy and reliability of the estimated subsurface model. By assembling these components together in a model update equation, the method can compute the model update in the wavenumber domain, thereby enhancing the efficiency and accuracy of the 3D inversion process.

Finally, an inverted model m is directly obtained in inverted model obtaining step 526 using, for example, equation (2) shown below which is the summation of the reference model m₀ and the update model δm.

$$m = {m}_{0} + δ m \qquad ( Eq . 2 )$$

It is noted that the system derives the inverted model directly from the model update without iterative refinement. This approach enhances the efficiency of the inversion process by reducing the computational resources and time requirements. In some cases, the processor in the FTG data processing server 606 may be configured to derive the model update using a computational strategy that calculates the kernel matrix and model covariance matrix in a manner that reduces the storage requirements. In other cases, the processor in the FTG data processing server 606 may be configured to derive the model update by calculating and utilizing the first row of the kernel matrix and model covariance matrix to represent the behavior of the full matrices. These variations can further enhance the efficiency of the inversion process by reducing the memory requirements.

The process concludes with the end of inversion step 528, indicating the completion of the 3D inversion of the FTG data. The resulting inverted model provides a detailed and accurate representation of the Earth's subsurface, which can be used for various applications in the field of geophysics.

Referring to FIG. 6, a networked system 600 for FTG data processing is presented. The system 600 includes a user device 602, an FTG data processing server 606, and an FTG database server 604, all of which are interconnected via a network 612. The network 612 facilitates communication and data exchange within the system 600, enabling the user device 602 to interact with the FTG data processing server 606 and access the FTG database server 604.

The user device 602 can be any computing device (e.g., PC, smart device, etc.) capable of transmitting and receiving data over the network 612. The user device 602 can be used to initiate the FTG data processing by sending instructions to data processing server 606.

The FTG data processing server 606 is responsible for handling the computational tasks involved in the 3D inversion process. The FTG data processing server 606 includes a processor that is configured to perform various operations based on the input data. These operations include, but are not limited to, the inversion of the FTG data, one-time forward modeling in the wavenumber domain, computation of a depth-weighting function, computation of a model covariance matrix, and computation of a data error covariance matrix. In other words, in response to a command from user device 602, FTG data processing server 606 may retrieve relevant data from database server 604 and perform operations on the retrieved data as described in FIGS. 4 and 5.

The FTG database server 604 may be responsible for storing the collected FTG data, the processed data, and the estimated models of the subsurface. The FTG database server 604 provides a centralized storage solution for the system 600, allowing the FTG data processing server 606 to access and retrieve the stored data as and when it is needed for the 3D inversion process.

Among others, the processor in the FTG data processing server 606, as shown in FIG. 6, may be configured to utilize BiCGSTAB for performing the inversion, the one-time forward modeling, the depth-weighting function, the model covariance matrix, and the data error covariance matrix.

In some cases, the processor in the FTG data processing server 606 may be configured to employ Graphics Processing Unit (GPU) (not shown) acceleration to enhance the computational efficiency of the product calculations. The use of GPU acceleration allows for the efficient processing of large datasets, making the 3D inversion process more time-efficient and suitable for large-scale applications.

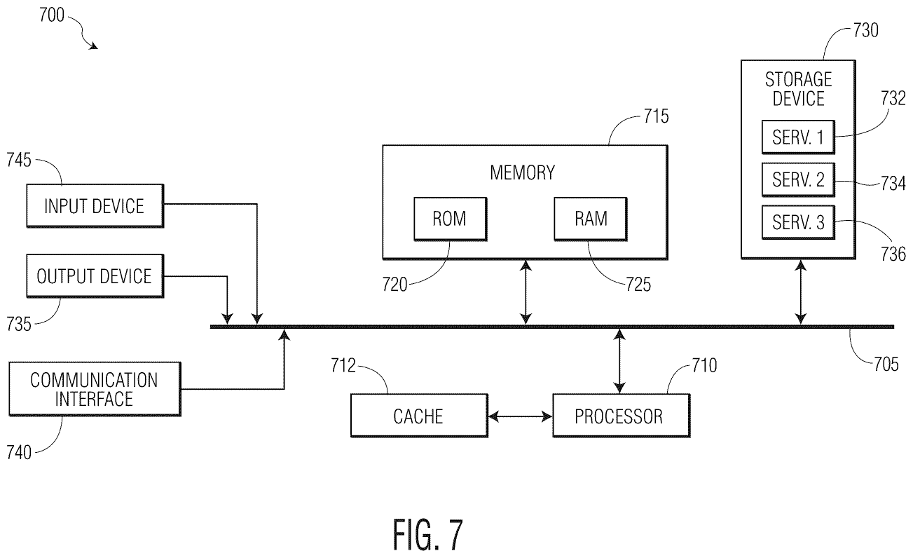

Referring to FIG. 7, a diagram 700 of representative hardware of the user device and FTG servers is presented. The hardware components of the user device and FTG servers are interconnected via a data bus 705, which facilitates the flow of information and control signals within the system. At the core of the system is a processor 710, which is responsible for executing various operations and computations as part of the 3D inversion process. The processor 710 is supported by a cache 712, which provides temporary data storage for the processor 710, enhancing the speed and efficiency of data processing.

The system also includes memory 715, which consists of both read-only memory (ROM) 720 and random-access memory (RAM) 725. The ROM 720 provides permanent storage for firmware and other system software, while the RAM 725 provides temporary storage for data and instructions that are currently being used by the processor 710. This arrangement allows the processor 710 to quickly access and process data, enhancing the overall performance of the system.

A storage device 730 is included in the system, which houses multiple services, labeled as service 1 732, service 2 734, and service 3 736. These services represent modular components or software services within the system, which can be used to perform various tasks and operations as part of the 3D inversion process. For example, one service may be responsible for data input, another service may handle data processing, and yet another service may manage data output.

The system also features an output device 735 and an input device 745, which facilitate user interaction with the system. The output device 735 can be used to display results and other information to the user, while the input device 745 can be used by the user to input data and commands into the system.

A communication interface 740 is included in the system to enable network connectivity and data exchange. The communication interface 740 allows the user device and FTG servers to communicate with each other and with other devices over a network, facilitating the exchange of data and control signals. This enables the system to receive FTG data from an FTG sensor platform, process the data using the 3D inversion method, and output the estimated model of the subsurface.

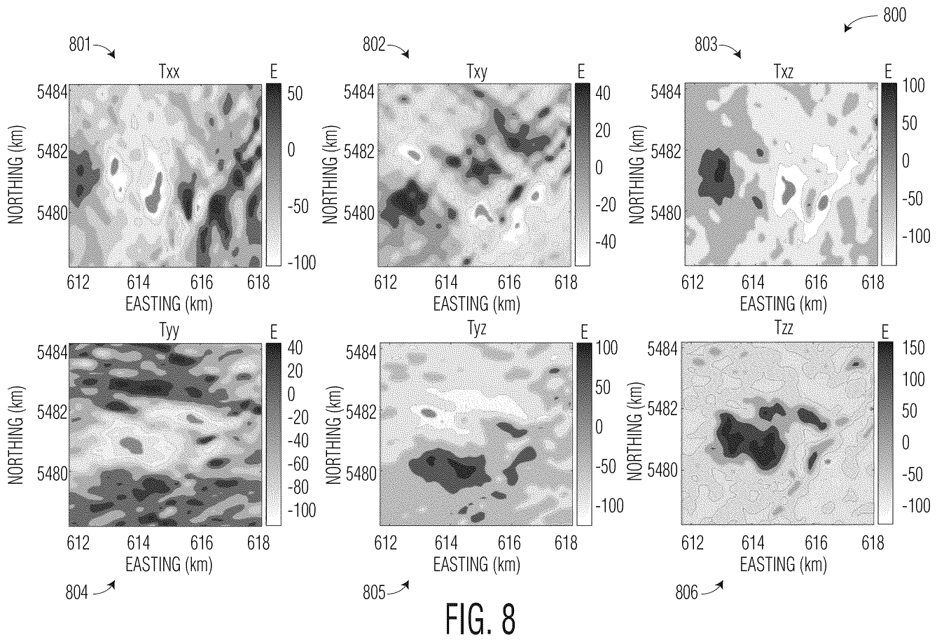

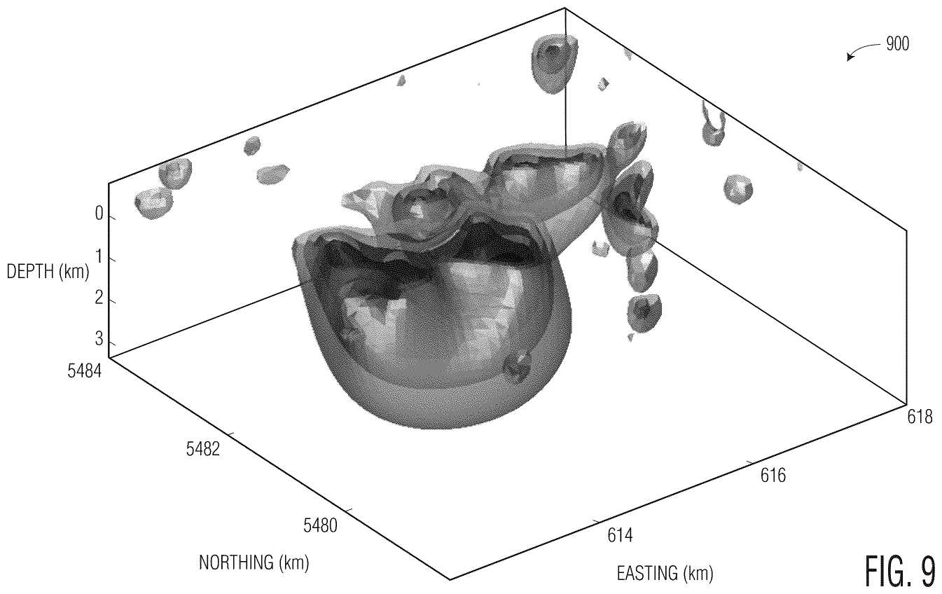

FIG. 8 and FIG. 9 depict results for the application of the fast-constrained 3D inversion method for gravity and FTG data by demonstrating its practical application and effectiveness in a real-world scenario. The gravity gradient tensor component maps in FIG. 8 showcase the method's ability to capture and visualize complex spatial variations in the gravitational field, while FIG. 9 presents a density model derived from the joint inversion of the FTG data, highlighting the method's capability to produce a detailed three-dimensional representation of subsurface density distribution. By successfully revealing the magmatic intrusion body and other significant geological structures in the Budgell Harbour Stock area of Newfoundland, these figures illustrate the method's potential to provide valuable insights for geophysical applications such as mineral exploration, geological mapping, and tectonic studies.

More specifically, FIG. 8 depicts a set of six gravity gradient tensor component maps 800 showing spatial variations in the gravitational field in the Budgell Harbour Stock, in Newfoundland. The maps include the Txx component 801, Txy component 802, and Txz component 803 in the top row, with the Tyy component 804, Tyz component 805, and Tzz component 806 in the bottom row. Each map displays the spatial distribution of gravity gradients across an area defined by Easting and Northing coordinates in kilometers, with grayscale intensity indicating the gradient values in Eötvös units (E).

The gravity gradient tensor component maps in FIG. 8 provide beneficial insights into the subsurface density distributions and geological structures in the Budgell Harbour Stock area. By visualizing the spatial patterns of different tensor components, geophysicists and geologists may identify anomalies, lineaments, and other features that could indicate the presence of geological structures or variations in rock density. The combination of these six tensor components may allow for a comprehensive analysis of the gravitational field, potentially revealing complex subsurface structures.

FIG. 9 presents a density model derived from the joint inversion of the FTG data shown in FIG. 8. The model provides a three-dimensional representation of the subsurface density distribution in the Budgell Harbour Stock area. In this visualization, density anomalies less than 0.15 g/cm³ have been removed to emphasize the magmatic intrusion body beneath the surface. This filtering technique allows for clearer identification and analysis of significant geological structures and density variations.

The density model in FIG. 9 offers beneficial insights into the subsurface geology of the area. By highlighting the magmatic intrusion body, geophysicists and geologists can potentially gain a better understanding of the region's geological history and structure. The model reveals the shape, size, and depth of the intrusion, which can be beneficial information for various applications such as mineral exploration, geological mapping, and understanding the area's tectonic evolution. The joint inversion approach used to create this model may provide a more comprehensive and accurate representation of the subsurface compared to models derived from individual data components.

While the disclosed solution has been described in the context of a specific hardware platform and algorithm, it is worth noting that there is flexibility for modifications and adaptations to both the hardware platform and the algorithm. This flexibility allows for the solution to be tailored to different use cases and scenarios, enhancing its applicability and utility in various contexts.

For instance, the hardware platform could be modified to include additional processing units or storage devices to handle larger datasets or more complex inversion tasks. The communication interface could also be upgraded to support faster data transfer rates or to accommodate different types of network protocols. Furthermore, the user interface could be enhanced to provide more intuitive controls or to display more detailed information about the inversion process and results.

Similarly, the algorithm could be adapted to incorporate different inversion methods or to utilize different types of prior information. The computation of the depth-weighting function, model covariance matrix, and data error covariance matrix could be optimized to improve the efficiency of the inversion process. The transformation of the TMI anomaly to the RTP or RTE anomaly could also be modified to better handle different types of magnetic data.

These are just a few examples of the possible modifications that could be made to the hardware platform and algorithm. The actual modifications would depend on the specific requirements and constraints of the use case at hand.

While the foregoing is directed to example embodiments described herein, other and further example embodiments may be devised without departing from the basic scope thereof. For example, aspects of the present disclosure may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A method for 3D inversion of Full Tensor Gradiometry (FTG) data, the method comprising:
receiving, by a processor, observed FTG data collected by an FTG sensor;
inputting, by the processor, the observed FTG data, gravity anomaly data and a reference density model;
performing, by the processor, a kernel matrix calculation on a subset of the observed FTG data and the gravity anomaly data;
performing, by the processor, one-time forward modeling in a wavenumber domain to produce predicted FTG data and predicted gravity anomaly data for the reference density model;
performing a residual between the observed data and predicted data;
performing, by the processor, a depth-weighting function, a model covariance matrix, and data error covariance matrix on the observed FTG data and observed gravity anomaly data;
obtaining, by the processor, a model update based on the depth-weighting function, kernel matrix, the model covariance matrix and the data error covariance matrix, and the residual between the observed FTG data and the predicted FTG data in the wavenumber domain; and
performing inversion by directly obtaining, by the processor, an inverted model based on the model update and reference model.

2. The method of claim 1, further comprising:
utilizing, by the processor, a biconjugate gradient stabilized method (BiCGSTAB) to perform the inversion, the one-time forward modeling, the depth-weighting function, the model covariance matrix, and the data error covariance matrix.

3. The method of claim 1, further comprising:
utilizing, by the processor, Graphics Processing Unit (GPU) acceleration to enhance computational efficiency of the inversion.

4. The method of claim 1, further comprising:
integrating, by the processor, prior information into the inversion through the model covariance matrix obtained by calculating spatial variogram functions to provide constraints on the inversion.

5. The method of claim 1, further comprising:
incorporating, by the processor, topography into the inversion to define an upper boundary of the model.

6. The method of claim 1, further comprising:
processing, by the processor, Total Magnetic Intensity (TMI) anomaly data to obtain Reduction to the Pole (RTP) or Reduction to the Equator (RTE) anomaly data for improved efficiency of inversion.

7. The method of claim 1, further comprising:
deriving, by the processor, the model update directly from the one-time forward modeling and inversion without iterative refinement.

8. The method of claim 1, further comprising:
deriving, by the processor, the model update using computational techniques that minimize a memory footprint by avoiding storage of large matrices.

9. The method of claim 1, further comprising:
deriving, by the processor, the model update using a computational strategy that calculates the kernel matrix and the model covariance matrix in a manner that reduces storage requirements.

10. The method of claim 1, further comprising:
deriving, by the processor, the model update by calculating and utilizing a first row of the kernel matrix and the model covariance matrix to represent the behavior of full matrices.

11. A system for 3D inversion of Full Tensor Gradiometry (FTG) data, the system comprising:
a processor configured to:
receive observed FTG data collected by an FTG sensor;
input the observed FTG data, observed gravity anomaly data and a reference density model;
perform a kernel matrix calculation on a subset of the observed FTG data and the observed gravity anomaly data;
execute one-time forward modeling in a wavenumber domain to produce predicted FTG data and predicted gravity anomaly data for the reference density model;
apply a depth-weighting function, compute a model covariance matrix, and compute a data error covariance matrix on the observed FTG data and observed gravity anomaly data, and compute a residual between the observed FTG data, the observed gravity anomaly data, the predicted FTG data and the predicted gravity anomaly data;
obtain a model update based on the depth-weighting function, the kernel matrix, the model covariance matrix, the data error covariance matrix, and the residual between the observed and predicted FTG data and the predicted gravity anomaly data in the wavenumber domain; and
perform an inversion to directly obtain an inverted model based on the model update and reference model.

12. The system of claim 11, wherein the processor is further configured to utilize a biconjugate gradient stabilized method (BiCGSTAB) for performing the inversion, the one-time forward modeling, the depth-weighting function, the model covariance matrix, and the data error covariance matrix.

13. The system of claim 11, wherein the processor is further configured to employ Graphics Processing Unit (GPU) acceleration to enhance computational efficiency of the inversion.

14. The system of claim 11, wherein the processor is further configured to integrate prior information into the inversion through the model covariance matrix by calculating spatial variogram functions to provide constraints on the inversion.

15. The system of claim 11, wherein the processor is further configured to incorporate topography into the inversion to define an upper boundary of the model.

16. The system of claim 11, wherein the processor is further configured to process Total Magnetic Intensity (TMI) anomaly data to obtain Reduction to the Pole (RTP) or Reduction to the Equator (RTE) anomaly data for improved efficiency of inversion.

17. The system of claim 11, wherein the processor is configured to derive the model update directly from the one-time forward modeling and inversion calculations without iterative refinement.

18. The system of claim 11, wherein the processor is configured to derive the model update using computational techniques that minimize a memory footprint by avoiding storage of large matrices.

19. The system of claim 11, wherein the processor is configured to derive the model update using a computational strategy that calculates the kernel matrix and the model covariance matrix in a manner that reduces storage requirements.

20. The system of claim 11, wherein the processor is configured to derive the model update by calculating and utilizing a first row of the kernel matrix and the model covariance matrix to represent a behavior of full matrices.
